(19) United States
(12) Patent Application Publication
(10) Pub. No.: US 2016/0203573 A1
(43) Pub. Date: Jul. 14, 2016

(54) System and Method for Retrieving and Displaying a Patent Family

(71) Applicant: Yin Huang, New York, NY (US)

(72) Inventor: Yin Huang, New York, NY (US)

(21) Appl. No.: 14/991,950

(22) Filed: Jan. 9, 2016

Related U.S. Application Data
(60) Provisional application No. 62/101,603, filed on Jan. 9, 2015.

(51) Int. Cl. G06Q 50/18; G06Q 10/10; G06F 17/30

(52) U.S. Cl. CPC G06Q 50/184; G06F 17/30554; G06Q 10/10

(57) ABSTRACT

The invention is a system and method for retrieving and displaying a patent family. The system may be an electronic device, the electronic device comprising a user interface, a database, means for displaying graphical output, and a storage medium containing a database and one or one software modules for retrieving records from the database. The method comprises receiving the number of a U.S. patent application, U.S. Patent Application Publication, or U.S. patent from a user; locating and retrieving from the database any record pertaining to the number; recursively retrieving from the database any records related to said record to construct a patent family; and rendering a diagram depicting the patent family.

### BACKGROUND OF THE INVENTION

The American parent system significantly influences economic activity. By defining exclusionary rights for inventions, patents effectively determine who may profit from new technologies. With more than 8,800,000 patents issued by the United States Patent and Trademark Office as of August 2014, the patent system touches nearly every field of technology. Where patents are asserted, damages routinely amount to millions of dollars. Even where no infringement is found, the length and complexity of patent litigation causes plaintiffs and defendants alike to incur huge legal expenses. In light of the financial implications if parent lawsuits, businesses routinely perform exhaustive reviews of patents to reduce the likelihood that their operations will provoke any patent lawsuit. Independently of litigation, businesses also engage in patent prosecution. Patent prosecution also requires extensive review of patents and related documents.

Reviewing patents, however, can be an arduous task. A single technology may implicate a collection of patents related to one another through complex legal rules. Under the system of priority claims within the American patent system, the development of a single underlying technology can result in the filing of multiple patent applications, which collectively form an application family. Moreover, a patent application may contain priority claims to a multitude of previous patent applications, thereby complicating the relationships within an application family.

When reviewing a patent or patent application, it is therefore of utmost importance to have complete information concerning any application family to which the patent or patent application may belong, including all priority claims within the application family. In the case of a patent, the failure to recognize a priority claim can result in a gross miscalculation of the patent term as well as an incorrect understanding of the scope of the invention. In the case of a patent application, such a failure may additionally result in a misjudgment as to whether the claimed invention is sufficiently different from prior art to qualify for a patent.

Identifying priority claims, however, is often far from straightforward. There are essentially three ways to identify any priority claims made in a patent or patent application.

The first and comparatively simplest way is to inspect the first page of a patent for any statement that a priority claim has been made. The problem with this approach is that indication of priority claims on the face of a patent can be haphazard. Some patents for which priority claims were made during prosecution simply fail to have any indication that any priority claim exists. This method is equally applicable to published patent applications, but the attendant drawbacks also apply.

The second way is to look up the patent using the United States Patent and Trademark Office's online recordkeeping system, named Patent Application Information Retrieval (“PAIR”). Though PAIR has comparatively better completeness of records pertaining to priority claims, it nonetheless contains a significant amount of inaccurate information. Incorrectly reported application numbers occur with some frequency. Data concerning priority claims are often voluminous but disorganized.

The third way is to inspect the prosecution filings of each patent to locate any references to previously filed patent applications. This method, however, is hampered by the need to sift through voluminous records. Combined with a leak of standardized formatting for priority claims among prosecution filings, the volume of records can result in an unmanageable workload.

In light of these difficulties, existing approaches to analyzing application families present a serious risk of misunderstanding crucial, legal information. An improved approach is therefore needed.

### BRIEF SUMMARY OF THE INVENTION

Unless otherwise noted, each of the following t has the meaning set forth in its definition:

“Database” means a software module capable of storing and retrieving records. By way of illustration but not limitation, a database may support Structured Query Language (“SQL”) or a variant thereof. By way of illustration but not limitation, a database may be an Oracle database, a MySQL database, a Microsoft SQL database, a PostgreSQL database, a MongoDB database, a Microsoft Access database, or a SQLite database.

“Record” means any collection of information stored as a retrievable unit within a database. By way of illustration but not limitation, a record may be a row within a database table. By way of illustration but not limitation, a record may include a primary key.

“Application” means a U.S. patent application, a foreign patent application, or a patent application filed under the Patent Cooperation Treaty.

“Application record” means any record concerning an application. By way of illustration but not limitation, an application record may include the application number and filing date of an application.

“Foreign application” means any patent application filed with an organization other than the United States Patent and Trademark Office. A PCT application, however, is not considered a foreign application.

“Foreign application record” means any record concerning a foreign application. By way of illustration but not limitation, a foreign application record may contain the application number, filing date, country of filing of a foreign application.

“PCT application” means any patent application filed under the Patent Cooperation Treaty.

“PCT application record” means any record concerning a PCT application. By way of illustration but not limitation, a PCT application record may contain the application number and filing date of a PCT application.

“Publication” means any U.S. Patent Application Publication.

“Publication record” means any record concerning a publication. By way of illustration but not limitation, a publication record may contain the publication number and publication date of a publication as well as the application number of the underlying application.

“Patent” means any U.S. patent.

“Patent record” means any record concerning a patent. By way of illustration but not limitation, a patent record may contain the patent number and issuance date of a patent as well as the application number of the underlying application.

“Priority claim” means assertion of priority right recognized by law in any country, geographic region, or other relevant jurisdiction. By way of illustration but not limitation, a priority right can be a claim for an effective filing date under 35 U.S.C. §119, 35 U.S.C. §120, or 35 U.S.C. §365. A priority claim includes an earlier application (the “parent application”), whose filing date is claimed as an effective filing date, and a later application (the “child application”), which receives the benefit of the claimed effective filing date.

“Priority record” means any record concerning a priority claim. By way of illustration but not limitation, a priority record may contain the application number of the patent application and the application number of the child application. By way of illustration but not limitation, a priority record may specify the particular statutory provision under which a priority is made.

“Application family” means any collection of applications where each application within the collection is the parent application or child application in at least one priority claim involving another application within the collection.

“Application family identifier” means any information capable of uniquely identifying an application family. By way of illustration but not limitation, an application family identifier can be an alphanumeric code (e.g., “F1”). By way of illustration but not limitation, an application family identifier can be generated by means of a hash function that uses one or more application records as input.

“Application family record set” means any collection of records concerning an application family. Each record within an application family record set is unique, so that the same record cannot be added to an application family record set more than once. By way of illustration but not limitation, any function used to add a record to an application family record set may be idempotent. By way of illustration but not limitation, an application family record set may contain an application record for each application in the underlying application family as well as a priority record for each priority claim within the underlying application family.

“Application family diagram” means any graphical representation of an application family. By way of illustration but not limitation, an application family diagram may be a directed acyclic graph.

“Patent family” means an application family that additionally includes any publication corresponding to any application within application family and any patent corresponding to any application within the application family.

“Patent family record set” means any collection of records concerning a patent family. By way of illustration but not limitation, a patent family record set may contain an application record for each application in a patent priority record for each priority within the patent family, a publication record for each publication in the patent family, and a patent record for each patent within the patent family. Every patent family record set is a superset of a corresponding application family record set.

“Document number” means an application number, a publication number, or a patent number. A document number need not be assigned by the United States Patent and Trademark Office.

“Search input” means any term or collection of terms through by which a user attempts to locate a record or a collection of records. By way of illustration but not limitation, a search input can be a document number, a single word (e.g., “mousetrap”), a collection of words (e.g., “computer keyboard”), or some combination thereof (e.g., “mousetrap from application Ser. No. 06/264,005”). A search input need not be in English and need not conform to rules of grammar or spelling. A search need not originate from a user. By way of illustration but not limitation, a search input may be received from another website by means of a so-called “URL parameter.”

The invention may be a system. In an embodiment, the system comprises an electronic device. The electronic device has a means for accepting input from a user. The input-accepting means may be a keyboard, a touchscreen, or any other mechanism that allows a user to enter an application number, a publication number, or a patent number. The electronic device has a means for displaying graphical output. The display means may be a monitor, a touchscreen, a projector, an e-ink display, or any other mechanism capable of rendering graphical output readily visible to a user.

The electronic device has a storage medium containing a database. The database may contain application records, publication records, patent records, and priority records. Records within the database may be organized into tables. By way of illustration but not limitation, the database may have a first table for application records, a second table for publication records, a third table for patent records, and a fourth table for priority records. By way of illustration but not limitation, the database may use foreign keys to ensure the referential integrity of record that refers to another record. The storage medium may additionally contain any software code needed to retrieve and display application families or patent families.

The system need not comprise a single electronic device. In an embodiment, the database may reside on a storage medium contained within a first device. The input-accepting means and display means may reside on a second device. The system may include means for transmitting input from the first device to the second device and transmitting outputs from the second device to the first device. The transmitting means may be an Internet connection, a connection within a local area network (“LAN”), or any other connection suitable for transmitting information relevant to the system.

The system may comprise a plurality of electronic devices sharing access to a single database. In an embodiment, the database resides on a server. A plurality of client devices may access the same database to retrieve records.

The invention may be a method. The method may be performed by a system comprising means for accepting user input, means for displaying graphical output, and a storage medium. The storage medium may contain a database storing application records, publication records, patent records, and priority records. The storage medium may contain a software module capable of performing the method.

In an embodiment, the system receives an application number from a user. The system then queries the database for an application record corresponding to the application number. If no corresponding application record is found, the system displays a message notifying the user that no corresponding application record has been found, and the method terminates.

If a corresponding application record is found, the system retrieves the corresponding application record. The system defines an application family record set, adds the retrieved application record to the set, and designates the application record as unmarked.

The system inspects the set for unmarked application records. For each unmarked application record in the set, the system queries the database for priority records identifying the unmarked application record. The system designates the unmarked application record application as marked. If one or more priority records are found, the system adds such priority records to the set. For each priority record that is found, the system reads the priority record, retrieves the related application record identified in the priority record, adds the related application record to the set, and designates the added application record as unmarked. The system then re-inspects the set for unmarked application records. This process, from inspection to re-inspection, results in a recursive expansion of the set. Such expansion of the set continues until no priority record identifies any unmarked application record within the set, at which point the expansion will terminate. Throughout the process of recursively expanding the set, the system complies with the requirement of uniqueness for records within the set. If the addition of any record to the set would result in the duplication of a record already within the set, such addition is not performed.

There is no predetermined maximum size for an application family or patent family. If the system encounters an exceptionally large application family patent family, the system may display a message notifying the user that records corresponding to such application family or patent family are voluminous.

The system renders an application family diagram. For each application record within the set, the system renders the application as a node. For each priority record within the set, the system renders the priority record as a link. By way of illustration but not limitation, a node may be a rectangle, and a link may be an arrow connecting a first node to a second node.

In an embodiment, the system receives a patent number instead of an application number. The system queries the database for a patent record corresponding to the patent number. If no corresponding patent record is found, the system displays a message notifying the user that no corresponding patent record has been found, and the method terminates. If a corresponding patent record is found, the system reads the patent record and retrieves a corresponding application record. The system may then remove the application family containing the application record.

In an embodiment, the system receives a publication number instead of an application number. The system queries the database for a publication record corresponding to the publication number. If no corresponding publication record is found, the system displays a message notifying the user that no corresponding publication record has been found, and the method terminates. If a corresponding publication record is found, the system reads the publication record and retrieves a corresponding application record. The system may then retrieve the application family containing the application record.

In an embodiment, an application family record set may be supplemented to form a patent family record set, and a corresponding patent family diagram may be rendered. For each application record in an application family record set, the system queries the database for any corresponding publication record and any corresponding patent record. If such corresponding record is found, the record is added to the application family record set. The result is a patent family record set. In a patent family diagram, each node may contain information from an application record, a corresponding publication record, and a corresponding patent record.

In an embodiment, one or more application records include an application family identifier.

In an embodiment, one or more priority records include an application identifier.

### BRIEF DESCRIPTION OF THE DRAWINGS

FIG. 1. is a schematic diagram showing the arrangement of information in the database of a possible embodiment of the invention. In the embodiment shown, the database contains a first table for application records, a second table for publication records, a third table for patent records, and a fourth table for priority records.

FIG. 2. is a schematic diagram showing the arrangement of application records in the database of a possible embodiment of the invention.

FIG. 3 is a schematic diagram showing the arrangement of publication records in the database of a possible embodiment of the invention.

FIG. 4 is a schematic diagram showing the arrangement of patent records in the database of a possible embodiment of the invention.

FIG. 5 is a schematic diagram showing the arrangement of priority records in the database of a possible embodiment of the invention.

FIG. 6 is a schematic diagram showing records may be stored in an application family record set.

FIG. 7 is a schematic diagram showing the method for retrieving an application family is a possible embodiment of the invention.

FIG. 8 shows an application family diagram that may be rendered by the invention.

FIG. 9 shows a patent family diagram that may be rendered by the invention.

FIG. 10 shows a second patent family diagram that may be rendered by the invention.

FIG. 11 shows a third patent family diagram that may be rendered by the invention.

FIG. 12 is a schematic diagram showing the use of an application family identifier to identify the individual application records within an application family record set.

### DETAILED DESCRIPTION OF THE INVENTION

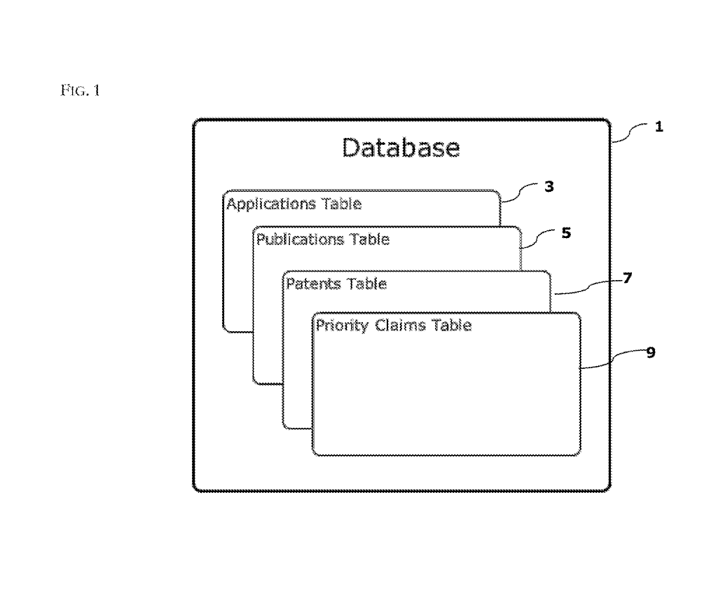

Referring to FIG. 1, the database 1 contains a first table containing a plurality of application records 4 (the “applications table 3”), a second table containing a plurality of publication records 6 (the “publications table 5”), a third table containing a plurality of patent records 8 (the “patents table 7”), and a fourth table containing a plurality of priority records 10 (the “priority claims table 9”). The particular combination of tables in FIG. 1 is not the only viable combination for storing records.

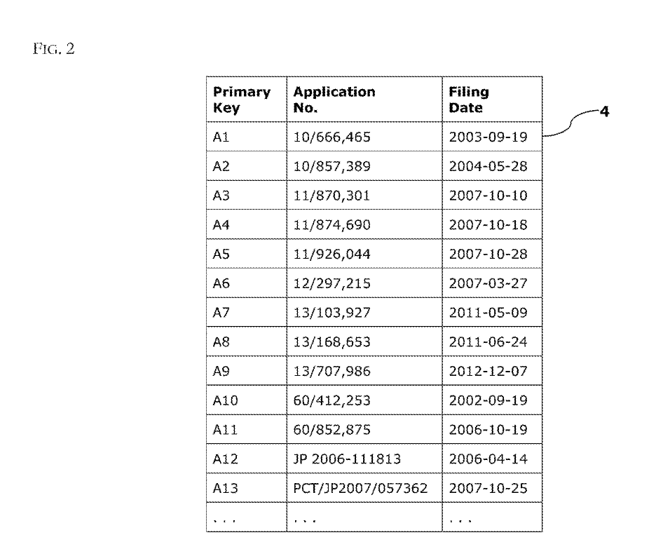

Referring to FIG. 2, the applications table 3 contains a plurality of application records 4. Each application record 4 contains an application number and a filing date.

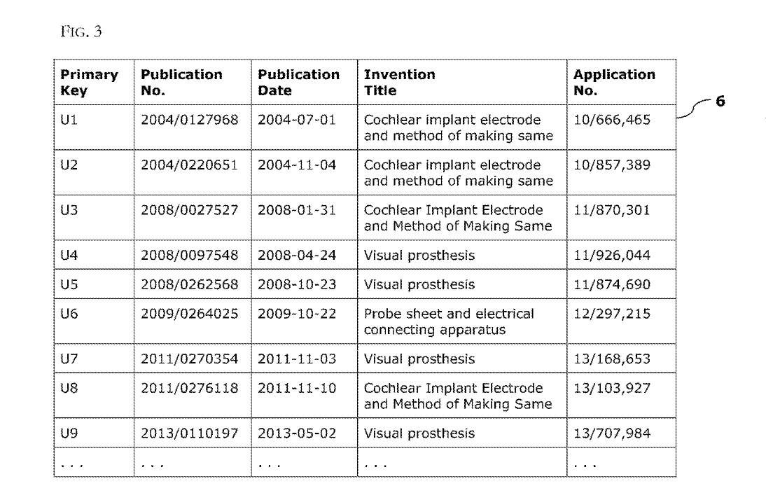

Referring to FIG. 3, the publications table 5 contains a plurality of publication records 6. Each publication record 6 contains a publication number, a publication date, an invention title, and the application number of the underlying application number. The application number allows each publication record 6 to be matched with a corresponding application record 4. Some application records 4 may not have corresponding publication records 6. By way of illustration but not limitation, an application record 4 may have no corresponding publication record 6 if the underlying application is abandoned before the application is published.

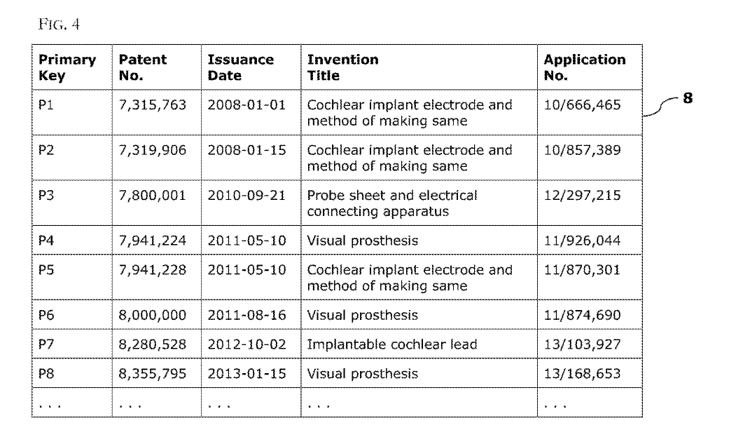

Referring to FIG. 4, the patents table 7 contains a plurality of patent records 8. Each patent record 8 contains a patent number, an issuance date, an invention title, and the application number of the underlying application number. The application number allows each patent record 8 to be matched with a corresponding application record 4. Some application records 4 may not have corresponding patent records 8. By way of illustration but not limitation, an application record 4 may have no corresponding patent record 8 if the underlying application is abandoned before a patent is issued for the application.

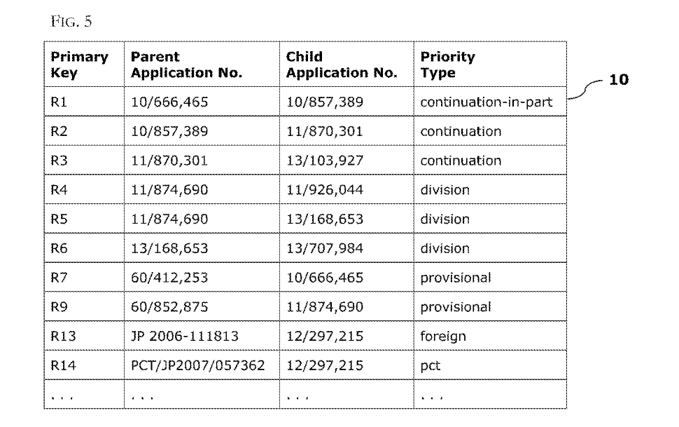

Referring to FIG. 5, the priority claims table 9 contains a plurality of priority records 10. Each priority record 10 contains the application number of a parent application, the application number of a child application, and a classification code. The classification codes shown in FIG. 5 include “provisional,” “continuation,” “continuation-in-part,” “divisional,” and “PCT.” Alternative classification codes are feasible.

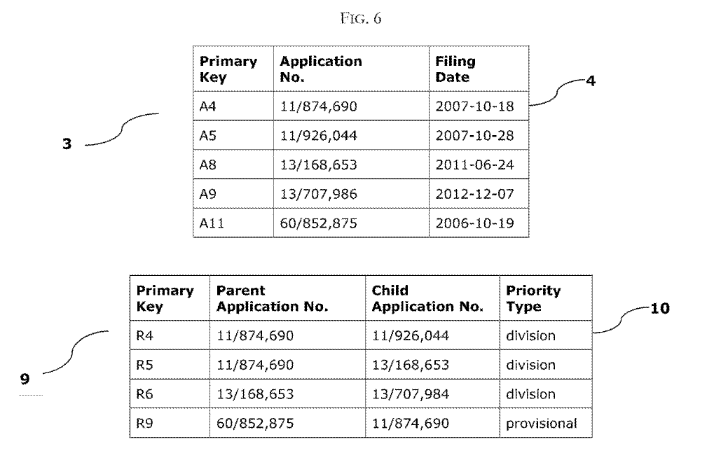

Referring to FIG. 6, an application family record set 29 may contain a plurality of application records 4 and a plurality of priority records 10 identifying the application records.

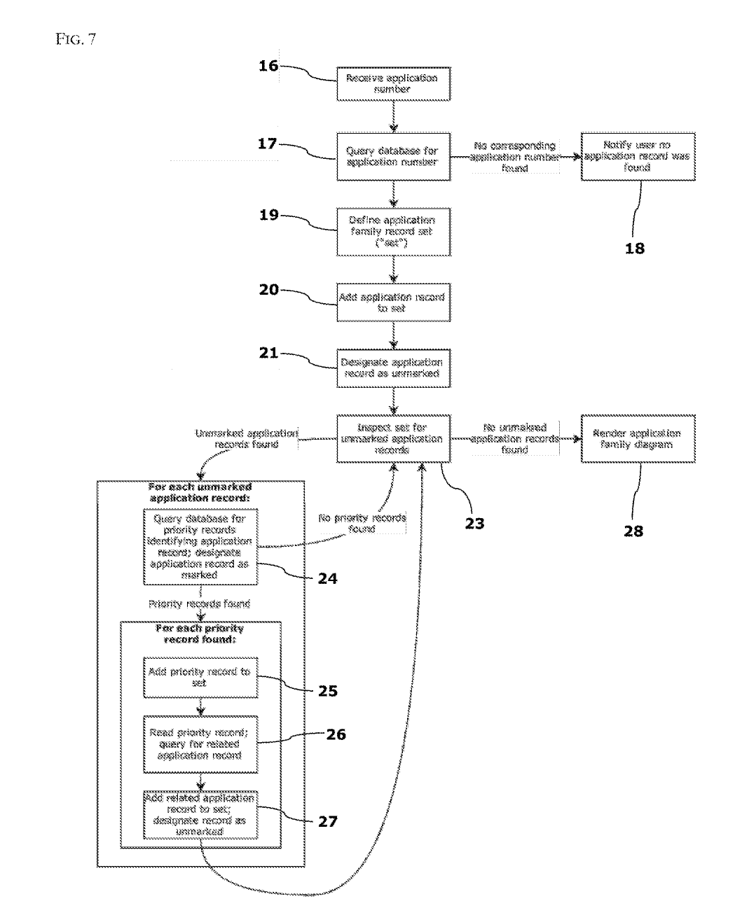

Referring to FIG. 7, the method for retrieving an application family begins with receiving an application number 16 from a user. The database is queried 17 for an application record 4 corresponding to the received application number. If no corresponding application record 4 is found, the user is notified 18 of the nonexistence of such record, whereupon the method terminates.

If a corresponding application record 4 is found, an application family record set 29 (“set”) is defined 19. The application record 4 is added 20 to the set 29 and designated as unmarked 21.

The set 29 is inspected 23 for unmarked application records 4. For each unmarked application record 4 in the set 29, the database is queried 24 for priority records 10 identifying the unmarked application record 4. The unmarked application is designated as marked 24. If one or more priority records 10 are found, the found priority records 10 are added 25 to the set 29. For each found priority record 10, the priority record 10 is read 26, and the related application record 4 identified by the priority record 10 is added 27 to the set 29 and designated as unmarked 27. The set 29 is re-inspected 23 for unmarked application records 4. If no unmarked application records 4 remain, an application family diagram is rendered 28.

Referring to FIG. 6 and FIG. 7, a user may invoke the method by entering the application No. “Ser. No. 11/874,690.” The application number is received 16, and the applications table 3 is queried 17 for application records 4 containing “Ser. No. 11/874,690.” Row A4 in the applications table 3 is revealed as an identifying application record 4. An application family record set 29 (“set”) is defined 19, and row A4 is added to the set 29 and designated as unmarked 27.

The set 29 is inspected 23 for unmarked records. Row A4 in the applications table 3 is revealed as an unmarked application record 4. The priority claims table 9 is queried 24 for priority records 10 containing “Ser. No. 11/874,690.” Row A4 is designated as marked. Rows R4, R5, and R9 in the priority claims table 9 are revealed as priority records 10 containing “Ser. No. 11/874,690.” Rows R4, R5, and R9 are added to the set 29. Rows R4, R5, and R9 are read 26, revealing Ser. Nos. 11/926,044, 13/168,653, and 60/852,875, respectively, as the application numbers of related applications. The applications table 3 is queried 26 for application records 4 matching each of the application numbers. Row A5 is revealed as an application record 4 corresponding to “Ser. No. 11/926,044.” Row A8 is revealed as an application record 4 corresponding to “Ser. No. 13/168,653.” Row A11 is revealed as an application record 4 corresponding to “Ser. No. 60/852,875.” Rows A5, A8, and A11 are added to the set 29. Rows A5, A8, and A11 are designated as unmarked 27. The set 29 is re-inspected 23 for unmarked application records 4.

Upon re-inspection 23, rows A5, A8, and A11 are found to be unmarked application records 4. Each of rows A5, A8, and A11 is processed in turn.

Row A5 contains the application “Ser. No. 11/926,044.” The priority claims table 9 is queried 24 for priority records 10 containing “Ser. No. 11/926,044.” Row A5 is designated as marked 24. Row R4 in the priority claims table 9 is revealed as a priority record 10 containing “Ser. No. 11/926,044.” Because row R4 is already in the set, the requirement of uniqueness means that row R4 is not added. to the set 29 a second rime. Row R4 is read 26, revealing “Ser. No. 11/874,690” to be the application number of a related application. The applications table 3 is queried 26 for application records 4 containing “Ser. No. 11/874,690.” Row A4 in the applications table 3 is revealed as an application record 4 containing “Ser. No. 11/874,690.” Because row A4 is already in the set 29, the requirement of uniqueness means that row A4 is not added to the set 29 a second time.

Row A8 contains the application number “Ser. No. 13/168,653.” The priority claims table 9 is queried 24 for priority records 10 containing “Ser. No. 13/168,653.” Row A8 is designated as marked 24. Rows R5 and R6 in the priority claims table 9 are revealed as priority records 10 containing “Ser. No. 13/168,653.” Because row R5 is already in the set 29, the requirement of uniqueness means that row R5 is not added to the set 29 a second time. Row R6 is added to the set 29. Rows R5 and R6 are read 26, revealing “Ser. No. 11/874,690” and “Ser. No. 13/707,984,” respectively, as the application numbers of related applications. The applications table 3 is queried 26 for application records 4 containing “Ser. No. 11/874,690” and “Ser. No. 13/707,984.” Row A4 is revealed as an application record 4 containing “Ser. No. 11/874,690.” Row A9 is revealed as an application record 4 containing “Ser. No. 13/707,984.” Because row A4 is already in the set 29, the requirement of uniqueness means that row A4 is not added to the set 29 a second time. Row A9 is added to the set 29. Row A9 is designated as unmarked 27.

Row A11 contains the application number “Ser. No. 60/852,875.” The priority claims table 9 is queried 24 for priority records 10 containing “Ser. No. 60/852,875.” Row A11 is designated as marked 24. Row R9 in priority claims table 9 is revealed as a priority record 10 containing “Ser. No. 60/852,875.” Because row R9 is already in the set 29, the requirement of uniqueness means that row R9 is not added to the set 29 a second time. Row R9 is read 26, revealing “Ser. No. 11/874,690” as the application number of a related application. The applications table 3 is queried 26 for application records 4 containing “Ser. No. 11/874,690.” Row A4 is revealed as an application record 4 containing “Ser. No. 11/874,690,” Because row A4 is already in the set 29, the requirement of uniqueness means that row A4 is not added to the set 29 a second time.

The set 29 is re-inspected 23 for unmarked application records 4.

Upon re-inspection, row A9 is found to be an unmarked application record 4. Row A9 contains the application number “Ser. No. 13/707,986.” The priority claims table 9 is queried 24 for priority records 10 containing “Ser. No. 13/707,986.” Row A9 is designated as marked 24. Row R6 in the priority claims table 9 is revealed as a priority record 10 containing “Ser. No. 13/707,986.” Because row R6 is already in the set, the requirement of uniqueness means that row R6 is not added to the set 29 a second time. Row R6 is read 26, revealing “Ser. No. 13/168,653” to be the application number of a related application. The applications table 3 is queried 26 for application records 4 containing “Ser. No. 13/168,653.” Row A8 in the applications table 3 is revealed as an application record 4 containing “Ser. No. 13/168,653.” Because row A8 is already in the set 29, the requirement of uniqueness means that row A4 is not added to the set 29 a second time.

The set 29 is re-inspected for unmarked application records 4.

The set 29 now contains no unmarked applications records. An application family diagram 11 is rendered 28.

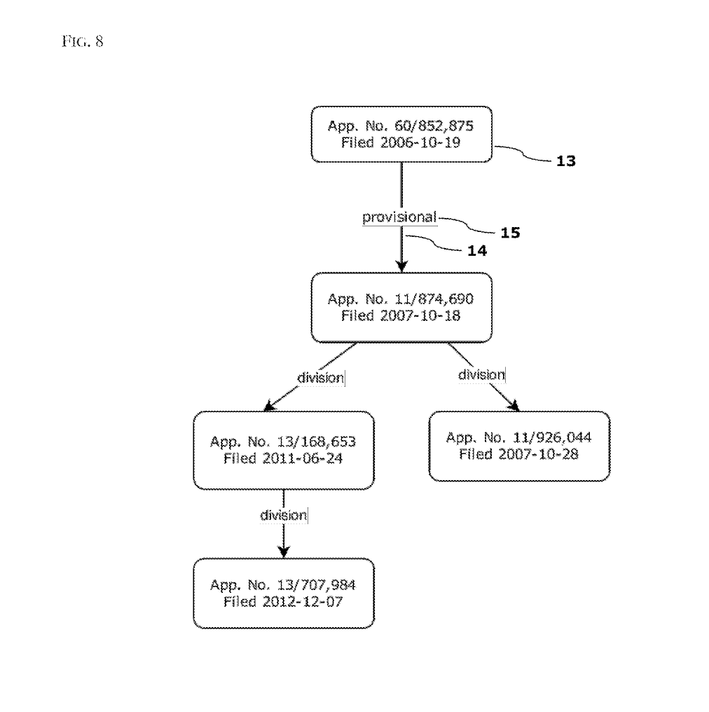

Referring to FIG. 8, an application family diagram 11 comprises a plurality of nodes and a plurality of links 14. A node 13 is a visual indicator of an application record 4. By way of illustration but not limitation, a node 13 may include the application number and filing date of an application. A link 14 is a visual indicator of a priority record 10. By was of illustration but not limitation, a link 14 may be an arrow pointing from the node 13 for a parent application to the node 13 for a child application. By way of illustration but not limitation, a link 14 may additionally have a label 15 stating the classification of the underlying priority claim. An application family diagram 11 is a directed acyclic, graph.

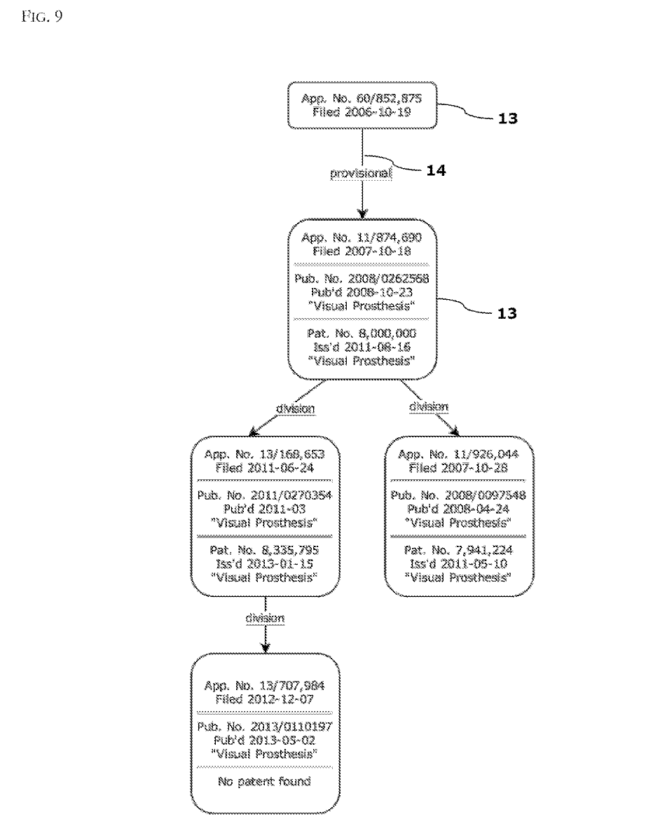

Referring to FIG. 9, the method may additionally retrieve records necessary to render a patent family diagram 12. Given a completed application family record set 29 (“set”), the set 29 may be supplemented with publication records 6 and patent records 8 to produce a patent family record set. For each application record 4 in the set 29, the database is queried for any publication record 6 corresponding to the application record 4. If a corresponding publication record 6 is found, the publication record 6 is added to the set 29. The database is queried for any patent record 8 corresponding to the application record 4. If a corresponding patent record 8 is found, the patent record 8 is added to the set 29.

The application family record set 29 containing the application number Ser. No. 11/874,690 (the “set”) may be supplemented to form a patent family record set. For each application record 4 in the set 29, the publications table 5 is queried for any publication record 6 identifying the application record 4, and the patents table 7 is queried for any patents record identifying the application record 4. Each of rows A4, A5, A8, A9, and A11 is processed in turn.

For row A4, the publications table 5 is queried for any publication record 6 containing “Ser. No. 11/874,690.” Row U5 of the publications table 5 is revealed as a corresponding publication record 6. Row U5 is added to the set 29. The patents table 7 is queried for any patent record 8 containing “Ser. No. 11/874,690.” Row P6 is revealed as a corresponding patent record 8. Row P6 is added to the set 29.

For row A5, the publications table 5 is queried for any publication record 6 containing “Ser. No. 11/926,044.” Row U4 of the publications table 5 is revealed as a corresponding publication record 6. Row U4 is added to the set 29. The patents table 7 is queried for any patent record 8 containing “Ser. No. 11/926,044.” Row P4 is revealed as a corresponding patent record 8. Row P4 is added to the set 29.

For row A8, the publications table 5 is queried for any publication record 6 containing “Ser. No. 13/168,653.” Row U7 of the publications table 5 is revealed as a corresponding publication record 6. Row U7 is added to the set 29. The patents table 7 is queried for any patent record 8 containing “Ser. No. 13,168/653.” Row P8 is revealed as a corresponding patent record 8. Row P8 is added to the set 29.

For row A9, the publications table 5 is queried for any publication record 6 containing “Ser. No. 13/707,984.” Row U9 of the publications table 5 is revealed as a corresponding publication record 6. Row U9 is added to the set 29. The patents table 7 is queried for any patent record 8 containing “Ser. No. 13/707,984.” No corresponding patent record 8 is found. Accordingly, no patent record 8 is added to the set 29.

For row A11, the publications table 5 is queried for any publication record 6 containing “60/852875.” No corresponding publication record 6 is found. Accordingly, no publication record 6 is added to the set 29. The patents table 7 is queried for any patent record 8 containing “60/852,875.” No corresponding patent record 8 is found. Accordingly, no patent record 8 is added to the set 29.

Referring to FIG. 9, a patent family diagram 12 is an application family diagram 11 that additionally displays information from publication records 6 and patent records 8. By way of illustration but limitation, a node 13 may contain the publication number, publication date, and publication title of a publication. By way of illustration but not limitation, a node 13 may contain the patent number, issuance date, and invention title of a patent.

Two or more priority claims may contain the same parent application so long as they do not also contain the same child application. Referring to BG. 8, application Ser. No. 11/874,690 is the parent application in two priority claims. In the first priority claim, the corresponding child application is application Ser. No. 13/168,653. In the second priority claim, the corresponding child application Ser. No. 11/926,044.

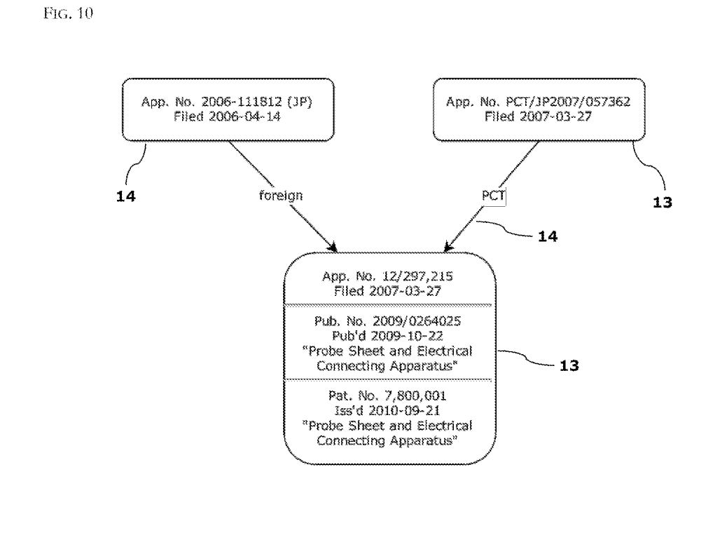

Two or more priority claims may contain the same child application so long as they do not also contain the same parent application. Referring to FIG. 10, application Ser. No. 12/297,215 is the child application in two priority claims. In the first priority claim, the corresponding parent application is Japanese application No. 2006-111812. In the second priority claim, the corresponding parent application is PCT application No. PCT/JP2007/057362.

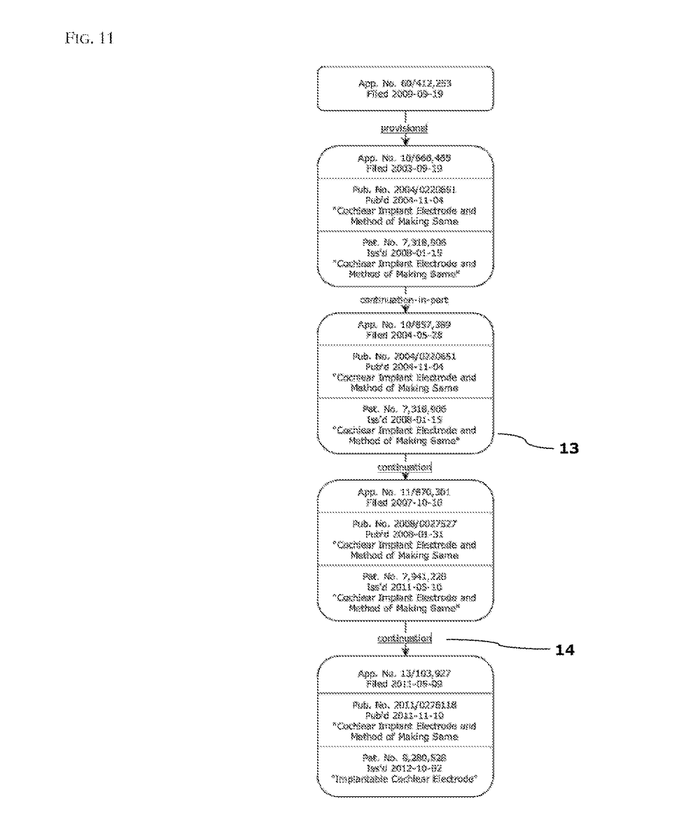

Referring to FIG. 11, an application family may contain any combination of provisional priority claims, continuation priority claims, continuation-in-part priority claims, divisional priority claims, foreign priority claims, and PCT priority claims.

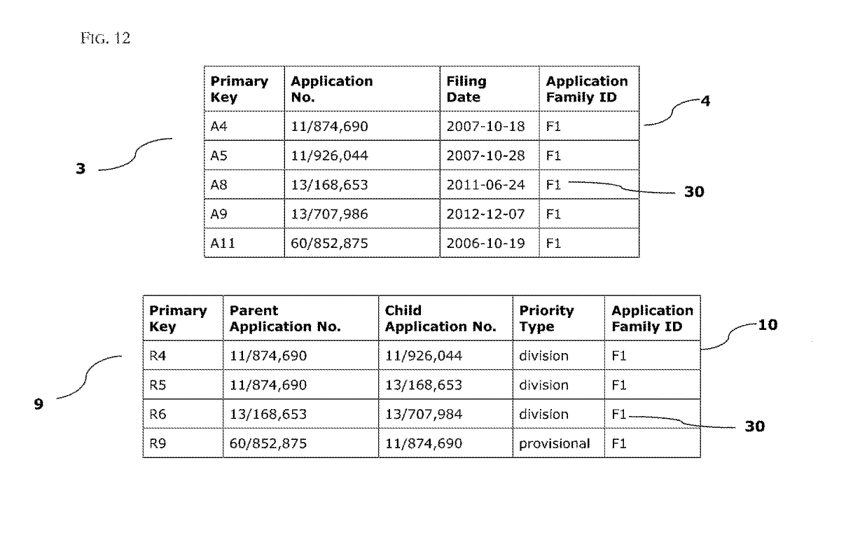

Referring to FIG. 12, one or more application records 4 and one or more priority records 10 may each include an application family identifier 30. An application family identifier 30 allows for a reduction in the number of database queries necessary to retrieve the records pertaining to an application family. By way of example, the document number “Ser. No. 11/874,690” may be received as a search input. A query of the applications table 3 reveals that application family identifier “F1” is associated with the application record for application Ser. No. 11/874,690. The remaining application records within the application family record set are then retrieved by querying the applications table 3 for all application records containing application family identifier “F1.” Likewise, all priority claims pertaining to the corresponding application family can be retrieved by querying the priority claims table 9 for all priority records containing application family identifier “F1.” Thus, where an application family identifier 30 is available for an application family, at most three database queries are needed to retrieve all records pertaining to the application family. Other tables within the database 1, such as the publications table 5 and the patents table 7, may also utilize records containing application family identifiers to facilitate the retrieval of application family record sets and patent family record sets.

What is claimed is:

1. A system for retrieving and displaying an application family, the system comprising:
means for accepting a search input;
means or displaying graphical output;
a storage medium, the storage medium containing:
a database;
and a software module, the software module capable of performing a method comprising:
receiving a search input;
constructing an application family record set corresponding to the search input;
and rendering an application family diagram.

2. The system of claim 1, wherein the search input is an application number.

3. The system of claim 1, wherein the search input is a publication number.

4. The system of claim 1, wherein the search input is a patent number.

5. A method of retrieving and displaying an application family, the method comprising using a software module to perform the following steps:
receiving a search input;
constructing an application family record set corresponding to the search input;
and rendering an application family diagram.

6. The method of claim 5, wherein the search input is an application number.

7. The method of claim 5, wherein the search input is a publication number.

8. The method of claim 5, wherein the search input is a patent number.
